(19) United States
(12) Patent Application Publication
(10) Pub. No.: US 2015/0379486 A1
(43) Pub. Date: Dec. 31, 2015

(54) SYSTEMS AND METHODS FOR AUTOMATIC ROUTINE PAYMENTS

(71) Applicant: EBAY INC., San Jose, CA (US)

(72) Inventor: Bret Christopher Verde, San Jose, CA (US)

(21) Appl. No.: 14/315,077

(22) Filed: Jun. 25, 2014

(51) Int. Cl. G06Q 20/10

(52) U.S. Cl. CPC G06Q 20/102

(57) ABSTRACT

According to an embodiment, a potential routine payment made for a routine service may automatically be identified based on payment history of a payment account. The potential routine payment may be suggested to a user of the payment account. With the user's permission, the potential routine payment may be designated as a routine payment. A schedule may be set up for the routine payment and payments may automatically be made from the payment account to a merchant providing the routine service based on the schedule. Further, the user may be reminded to receive the routine service based on the schedule. Follow-up reminders may be sent to the user when the routine payment has been made and the user has not visited the merchant to receive the routine service.

### BACKGROUND

1. Field of the Invention

The present invention generally relates to systems and methods for facilitating automatic routine payments.

2. Related Art

With the proliferation of Internet commerce, consumers increasingly are using online payment providers to facilitate payments to various merchants or service providers. These merchants may include merchants that provide routine services, such as routine automobile maintenance, routine prescription medicine, haircuts, routine medical or dental services, and the like. Sometimes it is difficult for customers to remember to visit the merchants or service providers to receive these routine services. As such, the routine services may be delayed or missed. Therefore, there is a need for a system or method that facilitates for these routine services and payments for these routine services.

### BRIEF DESCRIPTION OF THE FIGURES

FIG. 1 is a block diagram of a networked system suitable for implementing a process for facilitating routine payments according to an embodiment.

FIG. 2 is a flowchart showing a process for designating a routine payment according to one embodiment.

FIG. 3 is a flowchart showing a process for making a routine payment according to one embodiment.

FIG. 4 is a block diagram of a computer system suitable for implementing one or more components in FIG. 1 according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

According to an embodiment, a potential routine payment made for a routine (or periodic) service may automatically be identified based on payment history of a payment account. The potential routine payment may be suggested to a user of the payment account. With the user's permission, the potential routine payment may be designated as a routine payment. A schedule may be set up for the routine payment and payments may automatically be made from the payment account to a merchant providing the routine service based on the schedule. Further, the user may be reminded to receive the routine service based on the schedule. Follow-up reminders may be sent to the user when the routine payment has been made and the user has not visited the merchant to receive the routine service.

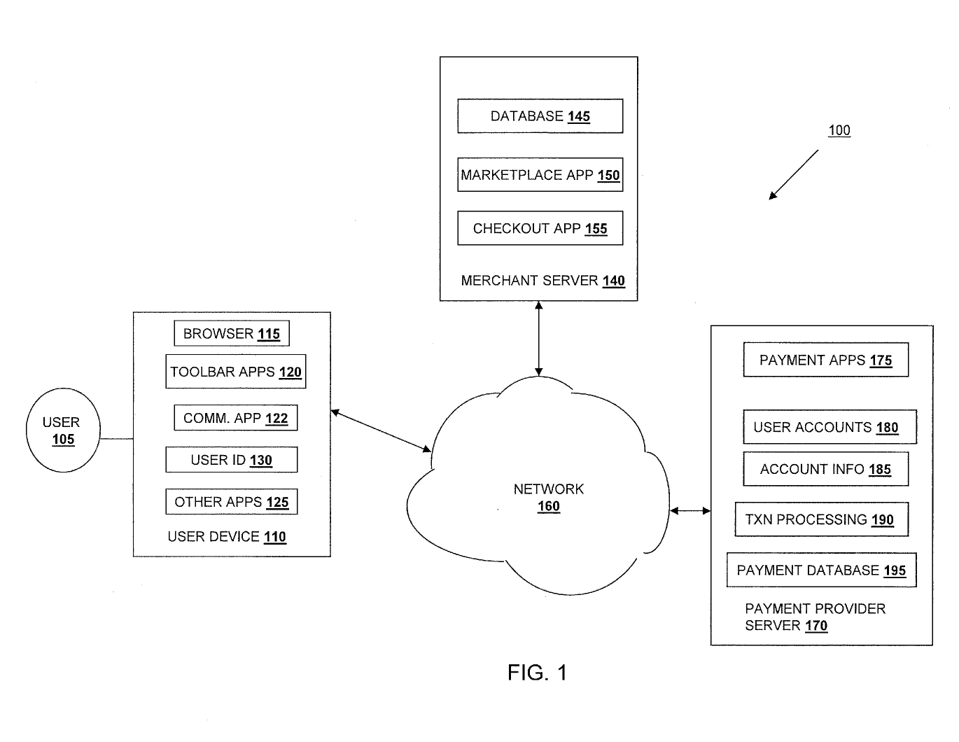

FIG. 1 is a block diagram of a networked system 100 suitable for implementing a process for facilitating routine payments according to an embodiment. Networked system 100 may comprise or implement a plurality of servers and/or software components that operate to perform various payment transactions or processes. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

System 100 may include a user device 110, a merchant server 140, and a payment provider server 170 in communication over a network 360. Payment provider server 170 may be maintained by a payment service provider, such as PayPal, Inc. of San Jose, Calif. A user 105, such as a sender or consumer, utilizes user device 110 to perform a transaction using payment provider server 170. A user 105 may utilize user device 110 to initiate a payment transaction, receive a transaction approval request, or reply to the request. Note that transaction, as used herein, refers to any suitable action performed using the user device, including payments, transfer of information, display of information, etc. Although only one merchant server is shown, a plurality of merchant servers may be utilized if the user is purchasing products or services from multiple merchants.

User device 110, merchant server 140, and payment provider server 170 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, user device 110 may be implemented as a personal computer (PC), a smart phone, personal digital assistant (PDA), laptop computer, and/or other types of computing devices capable of transmitting and/or receiving data, such as an iPad™ from Apple™.

User device 110 may include one or more browser applications 115 which may be used, for example, to provide a convenient interface to permit user 105 to browse information available over network 160. For example, in one embodiment, browser application 115 may be implemented as a web browser configured to view information available over the Internet, such as a user account for setting up a shopping list and/or merchant sites for viewing and purchasing products and services, User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 may further include other applications 125 as may be desired in particular embodiments to provide desired features to user device 110. For example, other applications 125 may include security applications for implementing client-side security features, programmatic client applications for interfacing with appropriate application programming interfaces (APIs) over network 160, or other types of applications.

Applications 125 may also include email, texting, voice and IM applications that allow user 105 to send and receive emails, calls, and texts through network 160, as well as applications that enable the user to communicate, transfer information, make payments, and otherwise utilize a smart wallet through the payment provider as discussed above. User device 110 includes one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a payment service provider to associate user 105 with a particular account maintained by the payment provider. A communications application 122, with associated interfaces, enables user device 110 to communicate within system 100.

User device 110 also may include applications that collect location data using Global Positioning System (GPS) to identify a location of user device 110. Other means for collecting location data, such as WiFi devices, Near-Field Communication (NFC) devices, or the like also may be included in user device 110 for determining a location of user device 110. Thus, user device 110 may determine a current location of user device 110 based on the collected location data. In another embodiment, user device 110 may send the location data to payment provider server 170 and payment provider server 170 may determine a current location of user device 110 based on the location data.

Merchant server 140 may be maintained, for example, by a merchant or seller offering various products and/or services. The merchant may have a physical point-of-sale (POS) store front. The merchant may be a participating merchant who has a merchant account with the payment service provider. Merchant server 140 may be used for POS or online purchases and transactions. Generally, merchant server 140 may be maintained by anyone or any entity that receives money, which includes charities as well as retailers and restaurants. For example, a payment may be a donation to charity. Merchant server 140 may include a database 145 identifying available products (including digital goods) and/or services (e.g., collectively referred to as items) which may be made available for viewing and purchase by user 105. Accordingly, merchant server 140 also may include a marketplace application 150 which may be configured to serve information over network 360 to browser 115 of user device 110. In one embodiment, user 105 may interact with marketplace application 150 through browser applications over network 160 in order to view various products, food items, or services identified in database 145.

Merchant server 140 also may include a checkout application 155 which may be configured to facilitate the purchase by user 105 of goods or services online or at a physical POS or store front. Checkout application 155 may be configured to accept payment information from or on behalf of user 105 through payment service provider server 170 over network 160. For example, checkout application 155 may receive and process a payment confirmation from payment service provider server 170, as well as transmit transaction information to the payment provider and receive information from the payment provider (e.g., a transaction ID). Checkout application 155 may be configured to receive payment via a plurality of payment methods including cash, credit cards, debit cards, checks, money orders, or the like.

Payment provider server 170 may be maintained, for example, by an online payment service provider which may provide payment between user 105 and the operator of merchant server 140. In this regard, payment provider server 170 includes one or more payment applications 175 which may be configured to interact with user device 110 and/or merchant server 140 over network 160 to facilitate the purchase of goods or services, communicate/display information, and send payments by user 105 of user device 110.

Payment provider server 170 also maintains a plurality of user accounts 180, each of which may include account information 185 associated with consumers, merchants, and funding sources, such as credit card companies. For example, account information 185 may include private financial information of users of devices such as account numbers, passwords, device identifiers, user names, phone numbers, credit card information, bank information, or other financial information which may be used to facilitate online transactions by user 105. Account information may also include payment history including payment transactions that were made previously from the payment account. The payment history may include payment transaction information, such as an amount of payment, the identity and type of merchant, product or service purchased, time and date of payment or purchase, and the like. Advantageously, payment application 175 may be configured to interact with merchant server 140 on behalf of user 105 during a transaction with checkout application 155 to track and manage purchases made by users and which and when funding sources are used.

A transaction processing application 190, which may be part of payment application 175 or separate, may be configured to receive information from user device 110 and/or merchant server 140 for processing and storage in a payment database 195. Transaction processing application 190 may include one or more applications to process information from user 105 for processing an order and payment using various selected funding instruments, including for initial purchase and payment after purchase as described herein. As such, transaction processing application 190 may store details of an order from individual users, including funding source used, credit options available, etc. Payment application 175 may be further configured to determine the existence of and to manage accounts for user 105, as well as create new accounts if necessary.

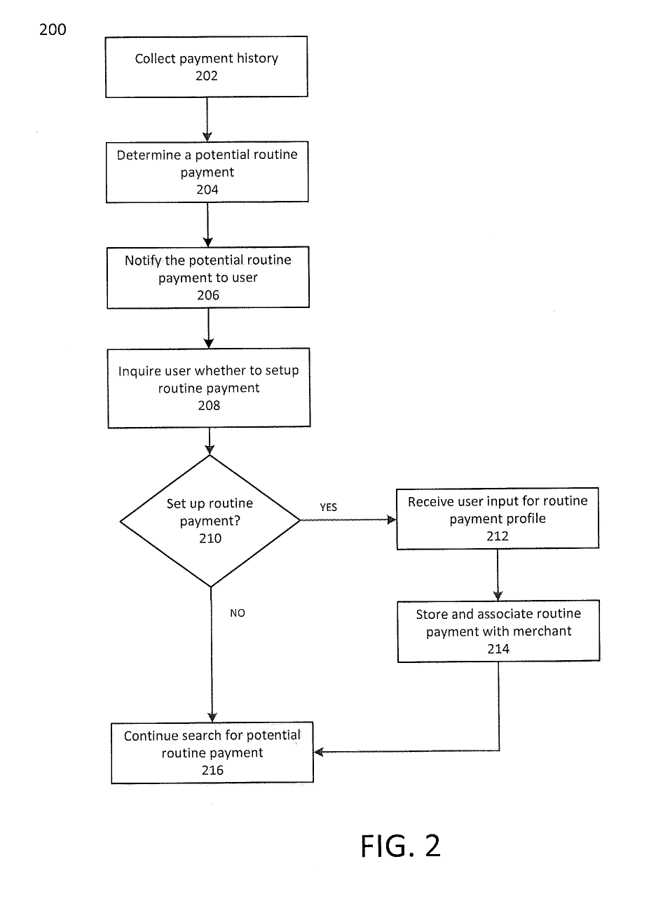

FIG. 2 is a flowchart showing a process 200 for designating a routine payment according to one embodiment. At step 202, payment provider server 170 may collect payment history. For example, for each purchase transaction, payment provider server 170 may collect information relating to the purchase transaction, such as purchase amount, identity and type of merchant, good or service purchased, time and date, location of the purchase, and the like made by or on behalf of the user, such as through a user account of the payment provider. Payment provider server 170 may store the collected payment history associated with a payment account or user in payment database 195. In one embodiment, user device 110 may collect and store the payment history of purchases made using user device 110 and/or other devices associated with the user or user account.

At step 204, payment provider server 170 may determine a potential routine payment based on the payment history. A potential routine payment may be similar amounts of payments that were made multiple times (which may be periodic, semi-periodic, or at some generally predictable pattern) to the same or similar merchants or for the same type of service or product. For example, payment provider server 170 may analyze the payment history and determine that similar payments for engine oil changes were made to the same auto mechanic multiple times at a relatively consistent frequency of once every three months. Payment provider server 170 may determine that payments at the auto mechanic for engine oil changes may be a potential routine payment.

Potential routine payments may be identified based on the amount of payment. For example, similar amounts of payments to the same or similar merchants may be identified to be a potential routine payment. Potential routine payments also may be identified based on the type of service or merchants. For example, payments made for visits to the same or similar type of merchant or service may be identified as a potential routine payment.

The frequency and repetition of payments also may be factors for identifying a potential routine payment. For example, when similar payments are made at a relatively consistent frequency, the payments may be identified as potential routine payments. Thus, payment provider server 170 may analyze the payment history to identify potential routine payments. Examples of potential routine payments may include payments for routine medical or dental checkups, routine prescription medicine, payments for annual or monthly membership or subscriptions, routine home or auto maintenance, haircut service, or the like. In one embodiment, user device 110 may determine potential routine payments based on the payment history.

At step 206, when a potential routine payment is identified, the potential routine payment may be notified to the user. For example, if payment provider server 170 identifies that payments for engine oil changes may be a routine payment for a routine service, payment provider server 170 may generate and send a notification to user device 110 to notify the user. In one embodiment, user device 110 may generate the notification to be displayed to the user. The notification may include information relating to the potential routine payment, such as the approximate payment amount, merchant identification, merchant type, product or service information, approximate frequency of payment, and the like. For example, the notification for the potential routine payment relating to the engine oil change may indicate that payments for approximate amount of $45.00 were made for engine oil change at an approximate frequency of once every three month and that the merchant is an automobile mechanic located at a certain address.

At step 208, a request to designate the potential routine payment as a routine payment may be generated and displayed to the user. For example, payment provider server 170 may send an inquiry to inquire whether the user wishes to designate the identified potential routine payment to be a routine payment. For example, the inquiry may state: “Would you like to make this payment for engine oil change at the auto mechanic a routine payment?” Buttons made be displayed for the user to select “Yes” or “No”.

At step 210, payment provider server 170 may determine whether to set up a routine payment for the potential routine payment based on the user input. If the user selects “Yes” requesting to set up a routine payment, payment provider server 170 may provide a form to receive user input for a routine payment profile at step 212. The routine payment profile may include settings for the routine payment, such as amount of payment, frequency of payment, method of payment, merchant or payee, reminders, and the like. The user may customize the settings for the routine payment by entering various parameters for the routine payment profile into the form. For example, the user may customize how much and how frequent the routine payments are to be made. Further, the user may choose the method of payment, such as using a payment account, a credit card, a bank account, or the like. The user also may choose how the user wants to be reminded regarding the services associated with the payment. For example, the user may choose to be reminded by an email to visit a dental office after a routine payment has been made for dental cleaning.

Payment provider server 170 may receive the user input and set up a routine payment profile for the routine payment. The profile of the routine payment may be stored in payment database 195 at step 214. The routine payment may be associated with the merchant or payee to which the routine payment is to be made. At step 216, payment provider server 170 may continue to search for and identify potential routine payments based on the payment history. This process allows payment provider server 170 to continuously learn the user's purchasing or payment activities or habits, and suggest appropriate potential routine payments to the user.

If the user selects “No” at step 210 requesting not to set up a routine payment, the process may go to step 216 to continue searching for other potential routine payments. In an embodiment, if a potential routine payment is not designated as a routine payment for the first time, the potential routine payment may be stored or flagged, such that no notification or request to set up routine payment is generated again for the same potential routine payment. Thus, after the user refuses to designate a certain potential routine payment for the first time, the user is not notified again for the same potential routine payment.

By using the above process 200, potential routine payments may automatically be identified and suggested to the user. The user may choose to designate certain payments as routine payments. The system may continuously learn the user's purchasing habits to provide better suggestions for the routine payments.

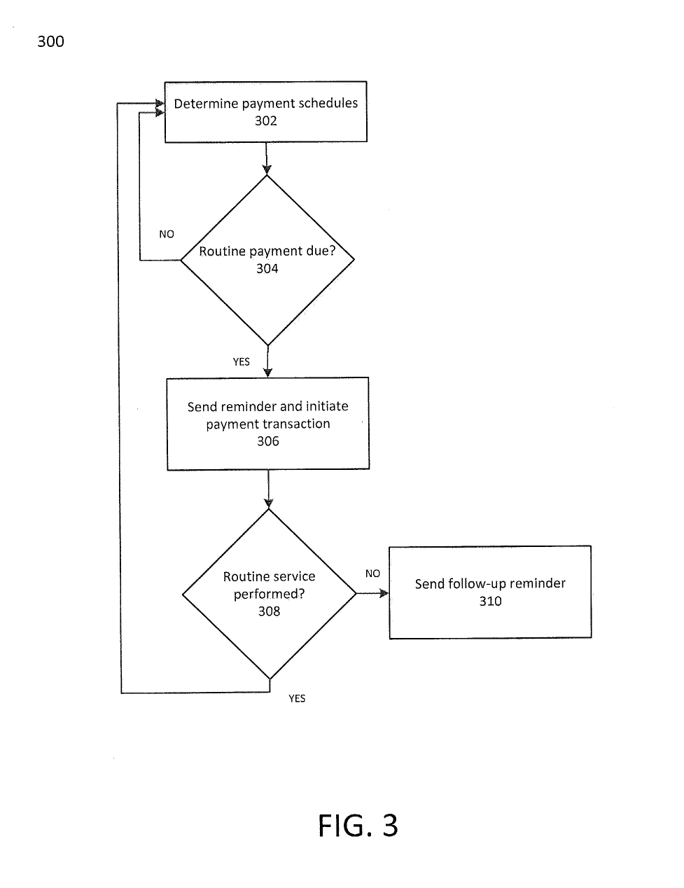

FIG. 3 is a flowchart showing a process for making a routine payment according to one embodiment. At step 302, payment provider server 170 may determine a payment schedule based on a routine payment profile. For example, based on the date and time of the initial payment and the frequency of payment, a schedule or calendar for the routine payments may be generated, e.g., making a payment on every fifth day of the month.

At step 304, payment provider server 170 may determine whether a routine payment is due. For example, payment provider server 170 may check the schedule for routine payments and the current time and date to determine whether a routine payment is due. Payment provider server 170 may keep track of multiple routine payments to various merchants for each payment account. If no routine payment is due, payment provider server 170 may continue to monitor routine payment schedules at step 302.

If a routine payment is due, payment provider server 170 may initiate a payment transaction for the routine payment at step 306. For example, payment provider server 170 may debit a payment amount from a payment account and credit a merchant account of a merchant to whom the routine payment is due. In other embodiments, payment may be made from a credit card, a bank account, or the like. Further, payment provider server 170 may generate and send a reminder to the user to remind the user that a payment is due and will be automatically paid. The reminder also may remind the user to visit the merchant to receive the routine service or product.

In one embodiment, after the routine payment is made, the merchant may prepare for the user's visit. For example, the merchant may prepare the products to be picked up by the user or schedule a service appointment for the user's visit. The merchant may send a ready confirmation to payment provider server 170 to indicate that the merchant is ready for the user's routine visit. For example, the ready confirmation may indicate that the products are packaged and ready for pick up or that a service appointment has been scheduled for the user. Payment provider servicer 170 may send out the notification or reminder to the user after receiving the ready confirmation from the merchant. Thus, the user may visit the merchant after the merchant has finished preparing the service or the products for the user's visit.

For a service providing merchant, after the routine payment is paid, the merchant may allow payment provider server 170 to access the merchant's service schedule. Payment provider server 170 may also access the user's schedule at user device 110. Thus, payment provider server 170 may select an appropriate time for the user to visit the merchant, e.g., a mutual available time between the merchant's service schedule and the user's schedule. Payment provider server 170 may schedule a service appointment for the user based on the merchant's service schedule and the user's schedule.

After the routine payment is paid, payment provider server 170 may continue to monitor to determine whether the user has visited the merchant to receive the service or product for which the routine payment has been made. For example, merchant server 140 may send a confirmation to payment provider server 170 when the user visits the merchant to receive the service or product. If the routine payment has been made and payment provider server 170 has not received a confirmation from merchant server 140 confirming that the user has visited the merchant to receive the service or the product, payment provider server 170 may send follow-up reminders to the user at step 310.

The follow-up reminders may be sent to the user at a certain frequency, e.g., every other day. In one embodiment, follow-up reminders may be sent based on the user's location or schedule. For example, user device 110 may monitor and collect location data, such as GPS location. User device 110 may send the location data of user device 110 to payment provider server 170. Payment provider server 170 may determine whether user device 110 is in the proximity of the merchant based on the location data of user device 110 and the address of the merchant. When user device 110 is in the proximity of the merchant, e.g., within one mile of the merchant, payment provider server 170 may send a follow-up reminder to encourage the user to visit the merchant. For example, the reminder may state: “Service charge for the engine oil change has been paid as a routine payment. You are near the auto-mechanic shop. Please remember to visit the auto-mechanic shop to receive the engine oil change service.” Thus, the user may be reminded to visit the merchant when the user is traveling to or near the merchant.

In one embodiment, payment provider server 170 may receive the user's calendar from user device 110. Payment provider server 170 may determine an available time of the user based on the calendar and generate a reminder based on the available time. For example, based on the user's calendar, payment provider server 170 may determine that the user is free in the afternoon. Payment provider server 170 may send a follow-up reminder that states: “Service charge for the engine oil change has been paid as a routine payment. It appears that you are free this afternoon. Would you like to visit the auto-mechanic shop to receive the engine oil change service?” Thus, the user may be reminded to visit the merchant at the user's convenient time.

If the routine service or product has been received by the user, as indicated by a confirmation sent from the merchant to payment provider sever 170, the process may return to step 302, in which payment provider server 170 may continue to monitor due dates of routine payments based on their schedules.

By using the above process, routine payments may be made automatically based on their respective schedules. The user may be reminded to visit the merchant to receive the routine service or product. In particular, the follow-up reminders may be generated and sent to the user at an appreciate time and place to encourage the user to visit the merchant.

The above steps in processes 200 and 300 may be executed at payment provider server 170. In one embodiment, the above steps in processes 200 and 300 may be executed at user device 110. In another embodiment, one or more steps may be executed at user device 110 or merchant server 140 while other steps may be executed at payment provider server 170.

The following are exemplary scenarios in which the above processes 200 and 300 may be implemented.

### Example 1

The user visits a pharmacy to pick up and pay for a prescription medicine on July 2. The user also visits the pharmacy to pick up and pay for the same prescription medicine on August 1 and September 3. These purchase transactions are stored in purchase history. Payment provider server 170 analyzes the payment history of the user and determines that the purchase of the prescription medicine at the pharmacy is a potential routine payment that occurs approximately once every month.

Payment provider server 170 sends a notification to user device 110 to notify the user about the potential routine payment. Payment provider server 170 also sends a request to designate the purchase of prescription medicine at the pharmacy as a routine payment. The user agrees to designate the purchase of prescription medicine as a routine payment that occurs once every month. The user also sets up a routine payment profile to allow automatic payment for the prescription medicine on the second day of every month for the next two years. The user requests that a reminder be sent to the user by text message when the routine payment is made.

Payment provider server 170 sets up a schedule for the routine payment based on the routine payment profile. Automatic routine payments are scheduled for the second day of every month starting on October 2 for two years. On October 2, payment provider server 170 determines that a routine payment is due to the pharmacy for the prescription medicine. Payment provider server 170 automatically debits the user's payment account and credits the pharmacy's merchant account for the amount of routine payment. Payment provider server 170 then sends a notification to merchant server 140 indicating that a routine payment has been made for the user. Merchant server 140 notifies the pharmacy to prepare the prescription medicine for the user to be picked up by the user.

After the pharmacy finishes preparing the prescription medicine, the pharmacy notifies payment provider server 170 that the prescription medicine is ready for pick up. Payment provider server 170 then sends a reminder to user device 110 to remind the user that a routine payment has been made to the pharmacy and that the user should visit the pharmacy to pick up the prescription medicine. The user does not visit the pharmacy on October 2. On October 4, the user visits a grocery store that is near the pharmacy. Payment provider server 170 receives the location data of user from user device 110 and determines that the user is in the proximity of the pharmacy. Payment provider server 170 also determines that the user has not visited the pharmacy to pick up the prescription medicine, because the pharmacy has not sent a confirmation of the user's visit to payment provider server 170. Thus, payment provider server 170 sends a follow-up reminder to user device 110 when the user is visiting the grocery store near the pharmacy to remind the user to pick up the prescription medicine. The follow-up reminder states: “Prescription medicine has been paid at the pharmacy. Remember to pick up the prescription medicine at the pharmacy, which is currently nearby.”

The user is reminded to pick up the prescription medicine at the pharmacy. After shopping at the grocery store, the user visits the pharmacy to pick up the prescription medicine. Merchant server 140 then sends a confirmation to payment provider server 170 to indicate that the user has visited the pharmacy to pick up the prescription medicine.

Thus, appropriate routine payments, such as prescription medicine, may be suggested to the user. The user may set up a routine payment profile for the prescription medicine. Further, the user may be reminded at the appropriate time and location to visit the pharmacy.

### Example 2

The user visits a coffee shop on the way to work between 8:00 AM and 8:30 AM every week day to purchase a cup of coffee. The purchase transactions are stored in the purchase history associated with the user's payment account. Payment provider server 170 analyzes the purchase history and determines that the purchase of a cup of coffee at the coffee shop is a potential routine payment that occurs between 8:00 AM to 8:30 AM every week day. Payment provider server 170 suggests this potential routine payment to the user. The user agrees to set up a routine payment for the coffee purchase.

The routine payment profile is set up to make automatic routine payments for a cup of coffee at the coffee shop between 8:00 AM and 8:30 AM every week day for the year. Payment provider server 170 sets up a schedule for the automatic routine payments for the year based on the payment profile. At 8:00 AM on Monday, payment provider server 170 determines that a routine payment to the coffee shop is due. Payment provider server 170 automatically processes the routine payment by debiting from the user's payment account and crediting the coffee shop's merchant account. After making the routine payment for a cup of coffee, payment provider server 170 notifies the coffee shop that a cup of coffee has been paid for the user. In response, the coffee shop begins to prepare the cup of coffee for the user to be picked up by the user. After the cup of coffee is prepared and ready, the coffee shop sends a ready confirmation to payment provider server 170. After receiving the ready confirmation, payment provider server 170 notifies the user at user device 110 that a cup of coffee has been paid at the coffee shop and reminds the user to pick up the cup of coffee on the way to work in the morning.

The user leaves home and travels to work. The user passes by the coffee shop on the way to work. Payment provider server 170 receives location data from user device 110. Payment provider server 170 determines that the user has not picked up the cup of coffee yet and is passing by the coffee shop based on the location data received from user device 110. Payment provider server 170 then sends a follow-up reminder to user device 110 to remind the user that “You are passing by the coffee shop. The cup of coffee is paid for and is waiting for your pick up.” The user is reminded and visits the coffee shop to pick up the cup of coffee. Merchant server 140 of the coffee shop then sends a confirmation to payment provider server 170 to indicate that the cup of coffee has been picked up by the user.

Thus, the user is reminded to pick up the coffee at the right time and place. Further, the coffee shop prepares the cup of coffee be picked up before the user visits the coffee shop. In addition, the user does not have to wait in line to order and pay for the cup of coffee, because it is automatically paid for by routine payment. Therefore, the automatic routine payment saves time and provides convenience for the user.

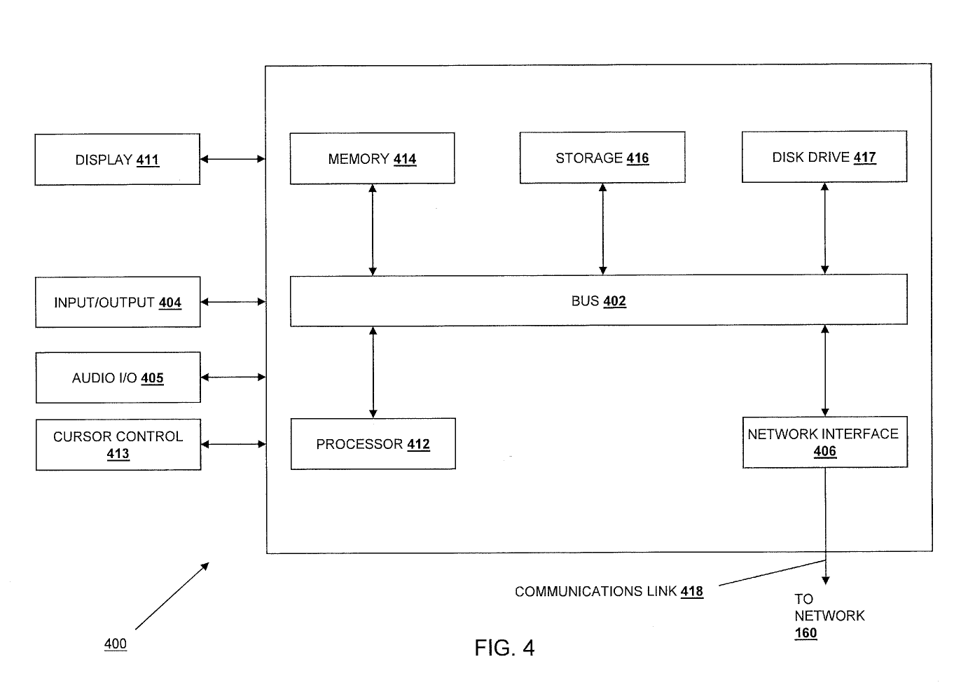

FIG. 4 is a block diagram of a computer system 400 suitable for implementing one or more embodiments of the present disclosure. In various implementations, the user device may comprise a personal computing device (e.g., smart phone, a computing tablet, a personal computer, laptop, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a payment provider server via network 360. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system for managing routine payments, the system comprising:
a hardware memory storing information about a payment account of a user, wherein the information comprises payment history to a same or similar merchant; and
one or more processors in communication with the memory and adapted to:
determine a potential routine payment based on the payment history;
designate the potential routine payment as a routine payment;
generate a schedule for the routine payment;
process the routine payment to a merchant when the routine payment is due based on the schedule; and
send a reminder notifying a user to visit the merchant after the payment is sent to the merchant.

2. The system of claim 1, wherein the potential routine payment is determined from the purchase history based on factors comprising one or more of: repetition of similar payments to the merchant, frequency of similar payments to the merchant, and types of goods or services associated with payments.

3. The system of claim 1, wherein the step of designating the potential routine payment as a routine payment comprises:
notifying the potential routine payment to the user;
requesting the user to designate the routine payment; and
setting up a routine payment profile for the routine payment based on user input from the user.

4. The system of claim 1, wherein the one or more processors are further adapted to:
send a notification to the merchant indicating that the routine payment is processed; and
receive a confirmation from the merchant when the user visits the merchant to receive a service or product associated with the routine payment.

5. The system of claim 4, wherein the one or more processors are further adapted to generate a follow-up reminder notifying the user to visit the merchant after the routine payment is made and the confirmation is not received.

6. The system of claim 5, wherein the one or more processors are further adapted to:
receive location data indicating a location of the user; and
send the follow-up reminder to the user when the user is in proximity of the merchant.

7. The system of claim 5, wherein the one or more processors are further adapted to:
receive calendar data indicating available time of the user; and
send the follow-up reminder to the user suggesting the user to visit the merchant during the available time.

8. The system of claim 1, wherein the one or more processors are further adapted to:
receive a service ready confirmation from the merchant indicating that the service associated with the routine payment is ready for the user; and
send the reminder to the user after receiving the service ready confirmation.

9. The system of claim 1, wherein the one or more processors are further adapted to:
receive a service schedule from the merchant;
receive a user schedule from the user; and
in response to sending the routine payment, schedule a service appointment at the merchant associated with the routine payment based on mutual available time indicated in the merchant's service schedule and the user schedule.

10. A method for managing routine payments, the method comprising:
receiving a payment history associated with a user;
determining, electronically by a hardware processor of a service provider, a potential routine payment based on the payment history;
designating the potential routine payment as a routine payment;
generating a schedule for the routine payment;
processing, electronically by the hardware processor, the routine payment to a merchant when the routine payment is due based on the schedule; and
sending, electronically by the hardware processor to a user device, a reminder notifying the user to visit the merchant after the payment is sent to the merchant.

11. The method of claim 10, the potential routine payment is determined from the purchase history based on factors comprising one or more of: repetition of similar payments to the merchant, frequency of similar payments to the merchant, and types of goods or services associated with payments.

12. The method of claim 10, wherein the step of designating the potential routine payment as a routine payment comprises:
notifying the potential routine payment to the user;
requesting the user to designate the routine payment; and
setting up a routine payment profile for the routine payment based on user input from the user.

13. The method of claim 10 further comprising:
sending a notification to the merchant indicating that the routine payment is processed; and
receiving a confirmation from the merchant when the user visits the merchant to receive a service or product associated with the routine payment.

14. The method of claim 13 further comprising generating a follow-up reminder notifying the user to visit the merchant after the routine payment is made and the confirmation is not received.

15. The method of claim 14 further comprising:
receiving location data indicating a location of the user; and
sending the follow-up reminder to the user when the user is in proximity of the merchant.

16. The method of claim 14 further comprising:
receiving calendar data indicating available time of the user; and
sending the follow-up reminder to the user suggesting the user to visit the merchant during the available time.

17. The method of claim 10 further comprising:
receiving a service ready confirmation from the merchant indicating that the service associated with the routine payment is ready for the user; and
sending the reminder to the user after receiving the service ready confirmation.

18. The system of claim 10 further comprising:
receiving a service schedule from the merchant;
receiving a user schedule from the user; and
in response to sending the routine payment, scheduling a service appointment at the merchant associated with the routine payment based on mutual available time indicated in the merchant's service schedule and the user schedule.

19. A non-transitory machine-readable medium comprising a plurality of machine-readable instructions which when executed by one or more processors of a computer are adapted to cause the computer to perform a method comprising:
determining a potential routine payment based on the payment history;
designating the potential routine payment as a routine payment;
generating a schedule for the routine payment;
processing the routine payment to a merchant when the routine payment is due based on the schedule; and
sending a reminder notifying a user to visit the merchant after the payment is sent to the merchant.

20. The non-transitory machine-readable medium of claim 19, wherein the step of designating the potential routine payment as a routine payment comprises:
notifying the potential routine payment to the user;
requesting the user to designate the routine payment; and
setting up a routine payment profile for the routine payment based on user input from the user.
